(19) United States
(12) Patent Application Publication
(10) Pub. No.: US 2009/0103059 A1
(43) Pub. Date: Apr. 23, 2009

(54) PROJECTOR

(75) Inventor: CHENG-HUNG CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/061,897

(22) Filed: Apr. 3, 2008

(30) Foreign Application Priority Data
Oct. 19, 2007 (CN) 200710202166.1

(51) Int. Cl. G03B 21/14

(52) U.S. Cl. 353/119

(57) ABSTRACT

A projector includes a main body, a light source module, a protective cap, and a protective receptacle. The main body includes a portion with the light source module installed therein. The protective cap alternatively covers the portion of the main body during normal use. The protective receptacle alternatively covers the portion of the main body during replacement of the light source module and is capable of accommodating the light source module therein.

### BACKGROUND

1. Technical Field

The present invention relates to projectors and, particularly, to a suspendable projector with a safely replaceable light source.

2. Description of Related Art

Projectors in some situations are mounted on a wall, or are hung from a ceiling or a mounting bracket that holds the projectors in a desired orientation. For a hung projector, replacement of its light source module poses a danger to the operator if the light source module should fragment and fall onto the operator.

What is needed, therefore, is a projector with a light source module that can be safely replaced.

### SUMMARY

In accordance with an exemplary embodiment, a projector includes a main body, a light source module, a protective cap, and a protective receptacle. The main body includes a portion with the light source module installed therein. The protective cap alternatively covers the portion of the main body during normal use. The protective receptacle alternatively covers the portion of the main body during replacement of the light source module and is capable of accommodating the light source module therein.

Other advantages and novel features will be drawn from the following detailed description of at least one preferred embodiment, when considered in conjunction with the attached drawings.

### BRIEF DESCRIPTION OF THE DRAWINGS

Many aspects of the present projector can be better understood with reference to the following drawings. The components in the drawings are not necessarily drawn to scale, the emphasis instead being placed upon clearly illustrating the principles of the present projector. Moreover, in the drawings, like reference numerals designate corresponding parts throughout the several views.

FIG. 1 is an isometric exploded inverted view of a projector and a protective cap according to an exemplary embodiment.

FIG. 2 is an un-inverted view of the projector of FIG. 1 with a protective receptacle secured to the projector to replace the protective cap of FIG. 1.

FIG. 3 is an exploded, isometric view of the protective receptacle of FIG. 2.

### DETAILED DESCRIPTION OF THE EMBODIMENTS

Embodiments of the present projector will now be described in detail below and with reference to the drawings.

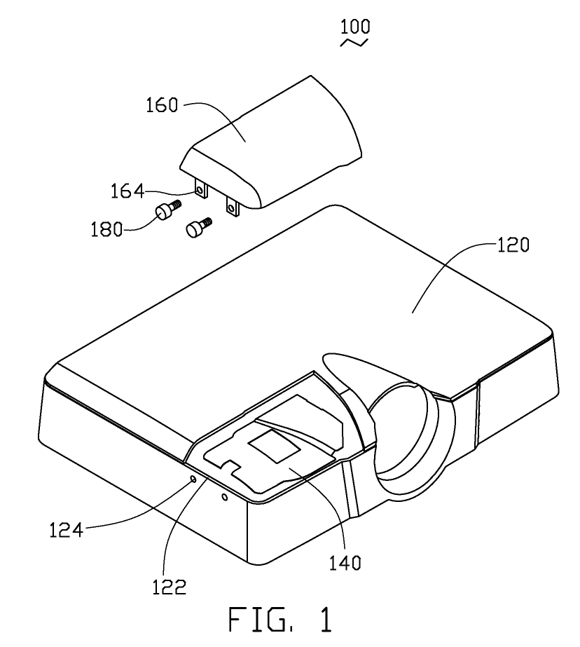

Referring to FIGS. 1-3, a hung projector 100 in accordance with an exemplary embodiment comprises a main body 120, a light source module 140, a protective cap 160, two screws 180, and a flexible protective receptacle 200.

Referring to FIG. 1, the main body 120 is illustrated in an inverted position, with the light source module 140 installed in a lower corner portion 122 thereof. The protective cap 160 can be secured to the lower corner portion 122 of the main body 120, for covering the light source module 140. To position the protective cap 160 to the main body 120, two through holes 164 are defined in the protective cap 160, for extension of the two screws 180 therethrough, which threadedly engage in screw holes 124 defined in the main body 120.

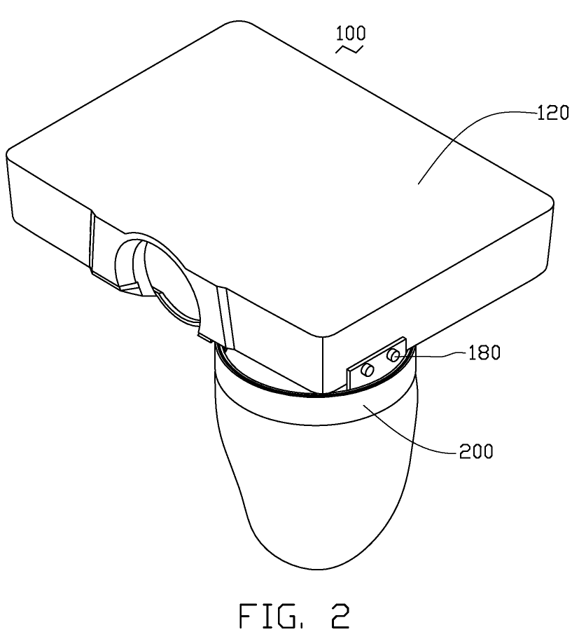

Referring to FIG. 2, the protective receptacle 200 is alternatively positioned at the lower corner portion 122 of the main body 120 of the projector 100, and fully covers the lower corner portion 122. The light source module 140 (shown in FIG. 1) can be thus covered by the protective receptacle 200 during its removal from the main body 120, and be accommodated in the protective receptacle 200 after it has been removed from the main body 120. Should fragments fall from the light source module 140, they are received in the flexible bag 250 of the protective receptacle 200. The flexible attribute of the protective receptacle 200 allows the operator to manipulate the light source module 140 through the material thereof. Therefore, replacement of the light source module 140 (shown in FIG. 1) is safe for the operator.

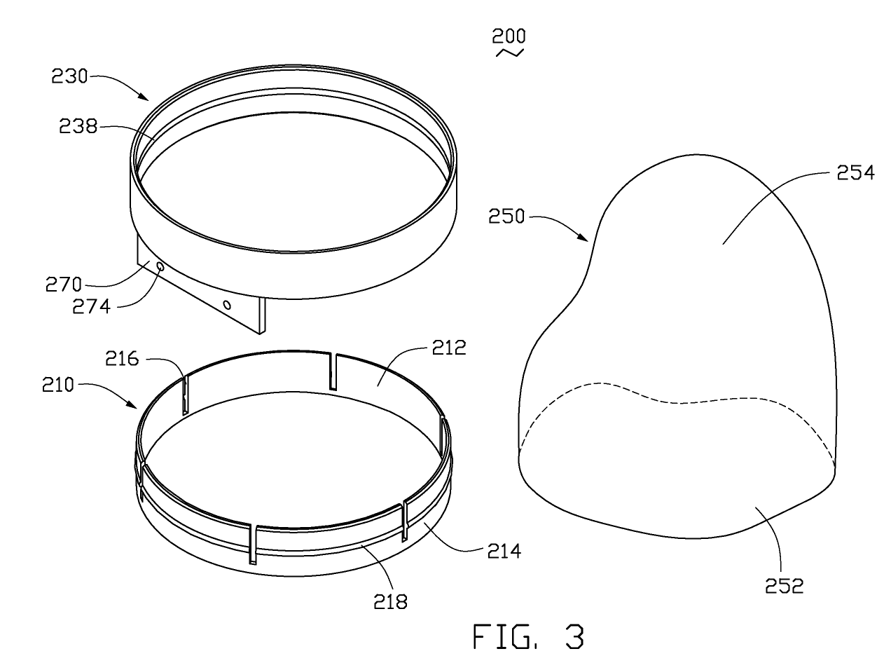

Referring to FIG. 3, the protective receptacle 200 comprises an inner ring 210, an outer ring 230, a flexible bag 250, and a fixing plate 270. The outer ring 230 is firmly sleeved around the inner ring 210, and cooperates with the inner ring 210 to fix an edge of the flexible bag 250 therebetween. The fixing plate 270 and the screws 180 cooperatively secure the protective receptacle 200 to the main body 120 of the projector 100.

The inner ring 210 comprises an inner surface 212, an outer surface 214, six slits 216, and a rib 218 encircling the inner ring 210. The slits 216 are distributed in the inner ring 210 at uniform intervals and extend across the rib 218 from an edge of the inner ring 210; thus, a portion of the inner ring 210 where the slits 216 are defined can be distorted inwardly, which facilitates the outer ring 230 to smoothly sleeve around the inner ring 210. Once the outer ring 230 fittingly sleeves around the inner ring 210, the distorted portion of the inner ring 210 rebounds back and abuts against an inner surface of the outer ring 230. The rib 218 is recessed from the inner surface 212 and raised from the outer surface 214, and disposed approximately midway between opposite edges of the inner ring 210.

The outer ring 230 defines an inner groove 238 encircling the outer ring 230. The groove 238 of the outer ring 230 correspondingly receives the rib 218 of the inner ring 210, which ensures an engagement of the inner ring 210 with the outer ring 230.

The flexible bag 250 is made of transparent material, such as transparent plastic in the embodiment. The flexible bag 250 comprises an engaging flange 252 received between the inner ring 210 and the outer ring 230, and an accommodating portion 254 for accommodating the light source module 140 after the light source module 140 is removed from the main body 120. In using the protective receptacle 200, the flexible bag 250 covers the lower corner portion 122 of the main body 120 so as to receive the whole of the light source module 140. This prevents fragments of the light source module 140 escaping out of the flexible bag 250 and can protect the operator.

The protective receptacle 200 can be positioned to the main body 120 by means of an engagement of the fixing plate 270 to the lower corner portion 122, or be held by hand. The fixing plate 270 is thus an optional element, and formed on the outer ring 230 as shown in FIG. 3, or alternatively formed on the inner ring 210 in other embodiments. The fixing plate 270 defines two through holes 274 therein corresponding to the screw holes 124 of the main body 120, for insertion of the screws 180 to secure the fixing plate 270 to the main body 120.

In the projector 100, the protective cap 160 and the protective receptacle 200 are alternatively positioned to the lower corner portion 122 of the main body 120, as needed. During normal use, the protective cap 160 covers the lower corner portion 122. When the light source module 140 needs to be replaced, the protective cap 160 is removed and replaced by the protective receptacle 200 for safe removal of the light source module 140 from the main body 120.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A projector comprising a main body, a light source module, a protective cap, and a protective receptacle, the main body including a portion with the light source module installed therein, the protective cap alternatively covering the portion of the main body during normal use, the protective receptacle alternatively covering the portion of the main body during replacement of the light source module and being capable of accommodating the light source module therein.

2. The projector as claimed in claim 1, wherein the protective receptacle comprises an inner ring, an outer ring sleeved around the inner ring, and a flexible bag, the flexible bag including an engaging flange fixed between the inner ring and the outer ring, and an accommodating portion for accommodating the light source module.

3. The projector as claimed in claim 2, wherein the protective receptacle comprises a fixing plate formed on one of the inner ring and the outer ring, and the fixing plate defines two through holes for extension of two screws which threadedly engage in screw holes defined in the main body.

4. The projector as claimed in claim 2, wherein the inner ring comprises a rib encircling the inner ring, and the outer ring defines a groove encircling the outer ring and receiving the rib therein.

5. The projector as claimed in claim 4, wherein the inner ring defines a plurality of slits extending across the rib from an edge of the inner ring.

6. The projector as claimed in claim 5, wherein the slits are evenly distributed in the inner ring.

7. The projector as claimed in claim 1, wherein the protective cap defines two through holes for extension of two screws which threadedly engage in screw holes defined in the main body.
